(19) United States
(12) Patent Application Publication
(10) Pub. No.: US 2020/0049405 A1
(43) Pub. Date: Feb. 13, 2020

(54) AIR HEATER FOR A DRYING TOWER AND DRYING TOWER FOR DRYING A PRODUCT TO BE DRIED

(71) Applicant: Lübbers Anlagen- Und Umwelttechnik Gmbh, Bad Langensalza (DE)

(72) Inventor: Matthias LÜBBERS, Bad Langensalza (DE)

(73) Assignee: Lübbers Anlagen- Und Umwelttechnik Gmbh, Bad Langensalza (DE)

(21) Appl. No.: 16/484,954

(22) PCT Filed: Jan. 31, 2018
(86) PCT No.: PCT/DE2018/200005

§ 371 Date: Oct. 8, 2019

(30) Foreign Application Priority Data
Feb. 10, 2017 (DE) 20 2017 100 733.2

(51) Int. Cl. F26B 21/00; F24H 3/10; F24H 9/00

(52) U.S. Cl. CPC F26B 21/001; F24H 3/105; F23D 91/02; F24H 9/0063; F24H 9/0068

(57) ABSTRACT

An air heater is used for a drying tower, wherein the air heater includes a combustion chamber, a burner, an air heating chamber, a process air access, a process air exit and/or a flue gas exit. During operation of the air heater, a process air is supplied to the air heating chamber by way of the process air access, a fuel is burned by means of the burner, a heat thus generated in the combustion chamber is transferred to the process air in the air heating chamber and the heated process air is discharged out of the air heater by way of the process air exit, and the air heater comprises an expendable combustion chamber, wherein the expendable combustion chamber is disposed within the combustion chamber. Further, a drying tower is used for drying a product to be dried with an air heater.

The invention relates to an air heater for a drying tower, wherein the air heater comprises a combustion chamber, a burner, an air heating chamber, a process air access, a process air exit and/or a flue gas exit, wherein, during operation of the air heater, a process air is supplied to the air heating chamber by way of the process air access, a fuel is burned by means of the burner, a heat generated thereby in the combustion chamber is discharged into the air heating chamber and the heated process air is discharged out of the air heater by way of the process air exit. The invention further relates to a drying tower for drying a product to be dried.

Air heaters serve for warming air for industrial processes and for heating buildings. Particularly in direct fired air heaters fluctuations in the temperature of the heated air can occur. Such temperature fluctuations are particularly undesirable in temperature-sensitive processes, for example when drying a product to be dried in a drying tower and/or spray dryer. Temperature fluctuations lead to a deterioration in the quality of the product to be dried and to a deposition of the product to be dried or of its components in the drying tower and/or spray dryer, which in turn leads to an increased risk of fire and/or explosion.

The problem underlying the invention is to improve upon the prior art.

The problem is solved by an air heater for a drying tower, wherein the air heater comprises a combustion chamber, a burner, an air heating chamber, a process air access, a process air exit and/or a flue gas exit, wherein the air heater is designed in such a manner that a process air is supplied to the air heating chamber by way of the process air access, a heat generated in the combustion chamber by means of the burner is transferred to the process air in the air heating chamber and the heated process air is discharged out of the air heater by way of the process air exit, wherein the air heater comprises an expendable combustion chamber and the expendable combustion chamber is disposed within the combustion chamber.

By means of the expendable combustion chamber, a uniform heat distribution within the combustion chamber and thus a more uniform transfer of the heat generated by the combustion to the process air in the air heating chamber are achieved.

In addition, a more complete combustion takes place within the combustion chamber, so that a post-oxidation on the clean gas side and undesirable emissions into the environment are reduced.

A flame generated by the burner generally impairs surrounding structures such as walls of the combustion chamber. Monitoring or accordingly replacing these walls is very costly. Here, the impairment concerns mainly the expendable combustion chamber, which can be advantageously replaced with little expense and effort, so that the durability and operational life of the combustion chamber can be significantly increased and the maintenance costs significantly reduced.

It is particularly advantageous that the heated process air, which leaves the air heater by way of the process air exit, is continuously supplied to an industrial process at a very constant temperature.

The following terms shall be explained:

An “air heater” is a device that transforms cold air (e.g. 20° C.) into heated process air. Such air heaters are used in particular in drying towers, in which a fluid is sprayed, for example, under pressure and thus atomized and in which the warm process air separates the water content from the product, so that a desired product remains, for example in powder form. The whey, for example, that is formed during the production of cheese, is thus filtered and the protein present in the whey is extracted by means of drying towers in the form of protein powder.

The “combustion chamber” is generally a container, in which a fuel is burned by way of an exothermic reaction by supplying an oxygen carrier (usually air). In this respect, the combustion chamber generally comprises an access for the oxidizer, here also referred to as combustion air supply.

In addition, the air heater comprises a “burner”, by means of which a flame is here generated in the combustion chamber. The burner is usually a gas burner in which a combustion gas is burned.

In addition, the combustion chamber comprises a “flue gas exit”, by way of which flue gases can be discharged. Such flue gas exit can comprise any catalytic converters for processing the flue gas or filters, which remove certain products from the flue gases.

The “expendable combustion chamber” is disposed within the combustion chamber, in order to transfer the heat homogeneously to the walls of the combustion chamber. This expendable combustion chamber is in particular a separate combustion chamber, which at least partially guides the flame of the burner and/or spatially limits its direct effects. This expendable combustion chamber can more specifically be open at the bottom and/or have a conical shape, which can result in chimney effects and the like on the combustion air. Because the expendable combustion chamber is directly heated by the flame and the corresponding heat can supply heat to the actual combustion chamber by way of the outer areas of the expendable combustion area, the expendable combustion chamber distributes the heat homogeneously into the combustion chamber. In addition, the heat distribution can be adjusted by way of the shape of the expendable combustion chamber. The material thicknesses of the expendable combustion chamber can also be adjusted in order to influence the heat output, in particular through heat radiation.

The “process air” is in particular the air that is heated by means of the combustion chamber and in particular supplied to the drying tower for the drying process. The air is guided to the “process air exit” by way of the “process air access” and the “air heating chamber”. In particular, the “air heating chamber” is very close to the combustion chamber. Thus, the process air can be heated by way of the air heating chamber by heating the walls of the combustion chamber. A wall of the combustion chamber can simply also be a wall of the air heating chamber. For example, the air heating chamber can run in a spiral, from bottom to top, along the wall of the combustion chamber.

The use of the expendable combustion chamber is also advantageous in that surface-increasing arrangements can be disposed on the combustion chamber walls, in order to optimize the heat transfer to the air heating chamber.

In another embodiment of the air heater, the expendable combustion chamber is disposed around a flame or part of a flame of the burner.

The flame temperature and/or the flow of the combustion gases is influenced in a targeted manner depending on the arrangement of the expendable combustion chamber around the flame. For example, by disposing the entire expendable combustion chamber around the flame, the temperature of the flame can be increased.

In order to achieve a targeted release of the combustion gases from the expendable combustion chamber, the expendable combustion chamber comprises several openings.

Thus, the temperature distribution and/or the flow guidance in the combustion chamber can be influenced in a targeted manner by means of the expendable combustion chamber.

In another embodiment of the air heater, the openings are distributed across a lateral surface of the expendable combustion chamber, so that a uniform heat distribution to the air heating chamber occurs.

The openings can be evenly and/or unevenly distributed across the lateral surface of the expendable combustion chamber.

It is particularly advantageous if the distribution of the openings is adapted to the various flame temperature areas and/or the shape of the flame.

In addition, the openings can have different opening sizes, so that the combustion gas flows through the respective opening at different speeds.

The openings are formed as boreholes and/or slits for easy production of the expendable combustion chamber and a targeted heat distribution in the combustion chamber.

In another embodiment of the air heater, the expendable combustion chamber has a surface temperature in the range of 700° C. to 900° C., preferably 800° C. during operation.

In order to achieve an optimal process temperature for a subsequent industrial process, the heated process air discharged from the air heater has a temperature in the range of 250° C. to 350° C., preferably 300° C., during operation.

It is particularly advantageous that, by using the expendable combustion chamber, the discharged process air has temperature variations of less than ±20° C., in particular of less than ±10° C., preferably less than ±5° C.

In another aspect of the invention, the problem is solved by a drying tower for drying a product to be dried, wherein a previously described air heater is associated, in terms of the technical process, with the drying tower or the drying tower comprises a previously described air heater.

Thus, the process air is provided to a drying tower at an optimal drying temperature. Consequently, a very homogeneous drying and a qualitatively high-grade drying result can be achieved.

In addition, the constant temperature of the process air allows avoiding a deposition and/or precipitation of undesired products in the drying tower, thus reducing the risk of fire and explosion and increasing the service life of the drying tower.

In the following, the invention will be explained in more detail based on an exemplary embodiment. In the drawings:

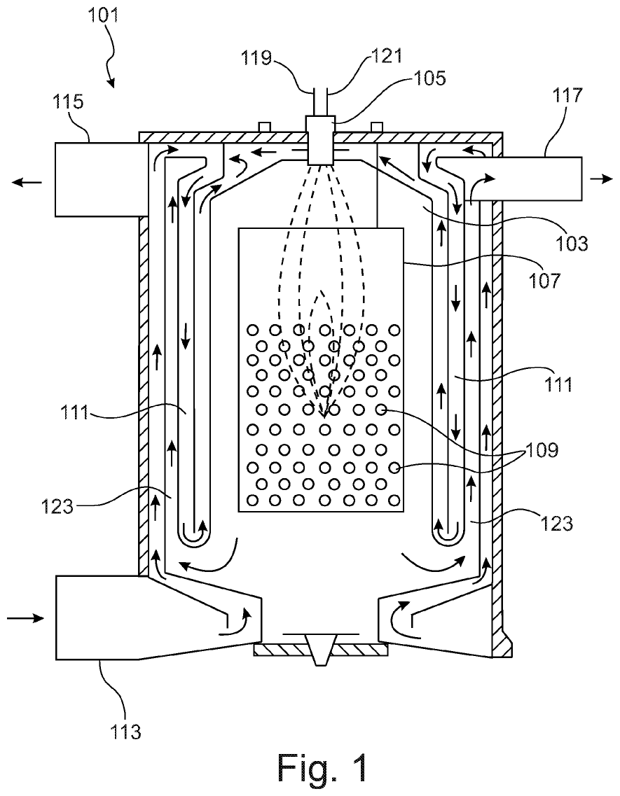

FIG. 1 shows a highly schematic sectional representation of an air heater with an expendable combustion chamber.

An air heater 101 comprises a combustion chamber 103. A burner 105 is disposed on an upper side of the combustion chamber 103. The burner 105 is connected with a combustion air supply 119 and a combustion gas supply 121. An expendable combustion chamber 107 is disposed under the burner 105 in middle of the combustion chamber 103. The expendable combustion chamber 107 comprises a plurality of holes 109, wherein the holes 109 are distributed differently in a lower area of the expendable combustion chamber 107 than in a middle area of the expendable combustion chamber 107.

In addition, the air heater 101 comprises a process air access 113 at the bottom, which is formed in a circular circumferential manner within the air heater 101. On its upper side and its lateral walls, the air heater 103 comprises a circularly circumferential air heating chamber 111, which is formed by meander-shaped flow channels. The air heating chamber 111 ends with a process air exit 115.

In addition, the combustion chamber 103 is connected with a circularly circumferential flue gas outlet 123, which ends with a flue gas exit 117.

In the air heater 101 a combustion gas is supplied to the burner 105 by way of the combustion gas supply 121 and a combustion air is supplied to the burner by way of the combustion air supply 119 and burned, whereby a corresponding flame is formed. The expendable combustion chamber 107 surrounds the downward oriented flame in the middle and lower area of the flame. In the middle and lower area of the expendable combustion chamber 107, the generated flue gases flow through the holes 109 into the combustion chamber 103.

In the upper area of the flame the expendable chamber 107 is free of any holes, as the flame temperature is lower there than at the tip of the flame, so that by surrounding the flame with the expendable combustion chamber 107 the flame temperature is increased in that area. The expendable combustion chamber 107 has a temperature of 800° C. at its surface.

A thermal energy of the combustion generated in the combustion chamber 103 is transferred from it to the circularly circumferential air heating chamber 111. In addition, process air is continuously introduced at an ambient temperature into the air heating chamber 111 by way of the process air access 113, wherein the process air warms up while flowing through the air heating chamber 111 and leaves the process air exit 115 at a temperature of 300° C.

The flue gases generated by the combustion in the combustion chamber 103 flow through the circular circumferential flue gas outlet 123, which has contact surfaces with the air heating chamber 111, so that a thermal energy of the flue gases is transferred to the process air in the air heating chamber 111. The flue gases leave the air heater 101 by way of the flue gas exit 123.

The heated process air having a temperature of 300° C. is supplied to a drying tower for drying milk after leaving the process air exit 115 of the air heater 101.

An air heater is thus provided that ensures an optimal utilization of combustion gas and an optimal process air temperature for the subsequent drying process in the drying tower as a result of a uniform heat distribution. In addition, the emissions caused by the flue gases are reduced as a result of the targeted control of the flame by way of the expendable combustion chamber.

### LIST OF REFERENCE NUMERALS

101 Air heater

103 Combustion chamber

105 Burner

107 Expendable combustion chamber

109 Holes

111 Air heating chamber

113 Process air access

115 Process air exit

117 Flue gas exit

119 Combustion air supply

121 Combustion air supply

123 Flue gas outlet

1. An air heater for a drying tower, wherein the air heater comprises:
a combustion chamber,
a burner,
an air heating chamber,
a process air access, and
a process air exit and/or a flue gas exit,
wherein the air heater is designed in such a manner that a process air is supplied to the air heating chamber by way of the process air access, a heat generated in the combustion chamber by the burner is transferred to the process air in the air heating chamber, wherein a heated process air is discharged out of the air heater by way of the process air exit, and wherein the air heater comprises an expendable combustion chamber and the expendable combustion chamber is disposed within the combustion chamber.

2. The air heater according to claim 1, wherein the expendable air chamber is disposed around a flame or a part of the flame of the burner.

3. The air heater according to claim 1, wherein the expendable combustion chamber has several openings.

4. The air heater according to claim 3, wherein the openings are distributed across a lateral surface of the expendable combustion chamber, so that a uniform heat distribution to the air heating chamber takes place.

5. The air heater according to claim 3, wherein the openings are formed as boreholes and/or slits.

6. The air heater according to claim 1, wherein the air heater is designed in such a manner that during operation, the expendable combustion chamber has a surface temperature in the range of 700° C. to 900°C.

7. The air heater according to claim 1, wherein the air heater is designed in such a manner that during operation, the heated process air discharged from the air heater has a temperature in the range of 250° C. to 350° C.

8. A drying tower for drying a product to be dried, characterized by the air heater according to claim 1.

9. The air heater according to claim 7, wherein the heated process air discharged from the air heater has a temperature in the range of 280° C. to 320° C.
